(19) United States
(12) Patent Application Publication
(10) Pub. No.: US 2012/0234752 A1
(43) Pub. Date: Sep. 20, 2012

(54) METHOD OF IMPROVING NITRIFICATION IN A TRICKLING FILTER

(76) Inventor: SCOTT DUNN, BETHEL PARK, PA (US)

(21) Appl. No.: 13/047,514

(22) Filed: Mar. 14, 2011

(51) Int. Cl. C02F 3/04

(52) U.S. Cl. 210/615; 210/435; 210/383

(57) ABSTRACT

A method of improving nitrification in a wastewater treatment plant is provided. The method comprises the steps of a) providing a trickling filter effluent water basin having biological filter media placed on a support platform positioned at least three feet above a bottom of the basin; and (b) contacting the filter media with the wastewater. Nitrification (removal of ammonia by conversion to nitrate) can be improved at least 30% as compared to a trickling filter without the invention.

### FIELD OF THE INVENTION

This invention relates to methods of treating wastewater in wastewater treatment plants. More specifically, the invention relates to nitrate removal from wastewater streams in plants using trickling filters.

### BACKGROUND OF THE INVENTION

Excessive nitrates in wastewater streams are related to a variety of problems. Some literature has shown that high levels of nitrate in water are associated with adverse health effects. The nitrate outflow onto shallow continental shelves can produce undesirable near-shore algae blooms. Nitrate's role as a plant nutrient can likewise cause undesirable plant growth in other water bodies such as ponds and lagoons. In the United States and Europe, legislation now specifies a maximum permissible nitrate and/or total nitrogen level in water for drinking or industrial discharge. Maximum legal nitrate levels in drinking water are currently 10 mg/liter (NO₃) in the United States. In the United States, Federal and State Agencies regulate nitrate concentrations in wastewater discharges and groundwater in an effort to reduce impact to the nation's water supply.

Conventional secondary wastewater treatment plants are generally designed to primarily reduce carbon and ammonia concentrations via biological treatment. Nitrogen removal is accomplished by converting ammonia contained in the mixed waste stream to nitrites and nitrates, in the presence of oxygen and known as an aerobic nitrifying stage. Ammonia conversion to nitrite is carried out by microbes known as Nitrosomonas, while the conversion of nitrite to nitrate is accomplished by Nitrobacters. Nitrate conversion to nitrogen gas occurs in an anoxic denitrifying stage that takes place in a suspended growth environment and is devoid of dissolved oxygen. Nitrogen, carbon dioxide and water is produced, with the gas being vented from the system.

Nitrification rates can be optimized by regulating interdependent waste stream parameters such as temperature, dissolved oxygen levels (D.O.), pH, solids retention time (SRT), ammonia concentration and BOD/TKN ratio (Total Kjeldahl Nitrogen, or TKN, is organic nitrogen plus the nitrogen from ammonia and ammonium). Higher temperatures and higher dissolved oxygen levels tend to promote increased nitrification rates, as does a pH level in the 7.0 to 8.0 range. Sludge retention times of from 3½ to 5 days dramatically increase nitrification efficiency, after which time efficiencies tend to remain constant.

Prior art techniques for removing nitrogen compounds from wastewater have either been ineffective or too expensive. What is needed is an inexpensive, effective method for removing nitrogen compounds such as ammonia from wastewater.

### SUMMARY OF THE INVENTION

Accordingly, in one aspect, the invention provides a method of improving nitrification in a wastewater treatment plant, the method comprising the steps of a) providing a trickling filter effluent water basin having biological filter media placed on a support platform positioned at least three feet above a bottom of the basin; and (b) contacting the filter media with the wastewater.

In additional aspects, the invention provides a trickling filter effluent water basin comprising: a) a retaining wall; b) a support platform to support filter media positioned at a height at least 3 feet above a bottom of the basin; and c) an outlet pipe in fluid communication with the storage space, wherein the trickling filter effluent water basin is a substantially closed system with the exception of an outlet pipe for effluent out of the basin.

The invention provides a cost-effective solution to the above described problem. By modifying existing trickling filter tanks or building new tanks with an elevated support platform for biological media, removal of nitrogen can be substantially improved without any additional effort. Additionally, the invention can be combined with the inventions disclosed in U.S. Pat. No. 7,238,286, fully incorporated herein by reference, for the purpose of providing overflow relief to wastewater treatment plants. In contrast to the inventions described in this above-referenced patent, the ventilation ports in embodiments of this invention are substantially removed or minimized in size, so that the water basin in some embodiments may not contain one or more ventilation ports defined in the retaining wall. It is thought that additional ventilation negatively affects the reduction in nitrification achieved by having a closed plenum.

As will be understood by one skilled in the art, embodiments of the invention can be used for both municipal and industrial wastewater treatment systems.

### BRIEF DESCRIPTION OF THE DRAWINGS

The invention is further illustrated by the following drawings in which:

FIG. 1 is a prior art schematic diagram of water flow through a wastewater treatment plant;

FIG. 2 is a top perspective, partially in section, view of a typical prior art trickling filter effluent water basin with rock media;

FIG. 3 is a top perspective, partially in section, view of another prior art trickling filter effluent water basin with newer plastic cross-flow block media;

FIG. 4 is a top perspective, partially in section, view of the modified trickling filter effluent basin made in accordance with an embodiment of the invention;

FIG. 5 is a top plan view of a portion of the embodiment shown in FIG. 4 without filter media.

### DETAILED DESCRIPTION OF THE INVENTION

As used herein, including the specification and the claims, all numerical references are to be read as including the term “about”. Any numerical range is intended to subsume each and every number contained within the range, as in “at least 30%” will include 31%, 32%, and the like, and the range “10% to 30% will include 10%, 11%, 12%, etc. and all numbers in between.

Accordingly, in some embodiments the invention provides substantially improved nitrification in wastewater treatment plants utilizing trickling filter effluent water basins. As used herein, the term “nitrification” means conversion of ammonia to nitrate. While not being bound by any theory, it is thought that the trickling filter of the invention gets its air through a down-draft convection air current created by the influent water being placed on the top of the filter by the rotary distributors. With limited or no ventilation portals, as the water flows down through the trickling filter media, it forces the air inside the large plenum up, as it has no place else to move. As the next arm of the rotary distributor passes by it is thought to create a down draft or vacuum, which forces fresh air down into the plenum. Because the air in the plenum is continually re-circulated in this manner, the temperature of the biological media stays consistent with the temp of the wastewater inflow. Since the temperature of the wastewater generally does not go below 55 degrees Fahrenheit (the same temperature as ground water) cold air that inhibits nitrification is never brought into the filter, even when the outside temperature drops well below freezing. As the air is re-circulated through the filter the microorganisms that are beneficial to nitrification removal are re-introduced into the filter, creating a stronger population of microorganisms in the trickling filter media.

Accordingly, a trickling filter of the invention is a substantially closed system with the exception of an outlet pipe for effluent out of the basin. As used herein, the term “substantially closed” means that there are minimal (very small in size) or no ventilation ports in the side walls of the filter tank. It is thought that ventilation ports will decrease the downdraft effect of air circulation through the plenum, diminishing the improvement in nitrification as ventilation ports increase in size.

In all figures, like numerals refer to like features having the same described function.

The terms “trickling filter effluent water basin”, “trickling filter tank” and “trickling filter” are used herein interchangeably and refer to a wastewater treatment tank in which water flows downward over biological media to remove soluble organic contaminants in the water, as is known in the art. Such tanks are used in both municipal and industrial wastewater treatment systems. As will be understood by one skilled in the art, any of the embodiments described herein can be used in either setting.

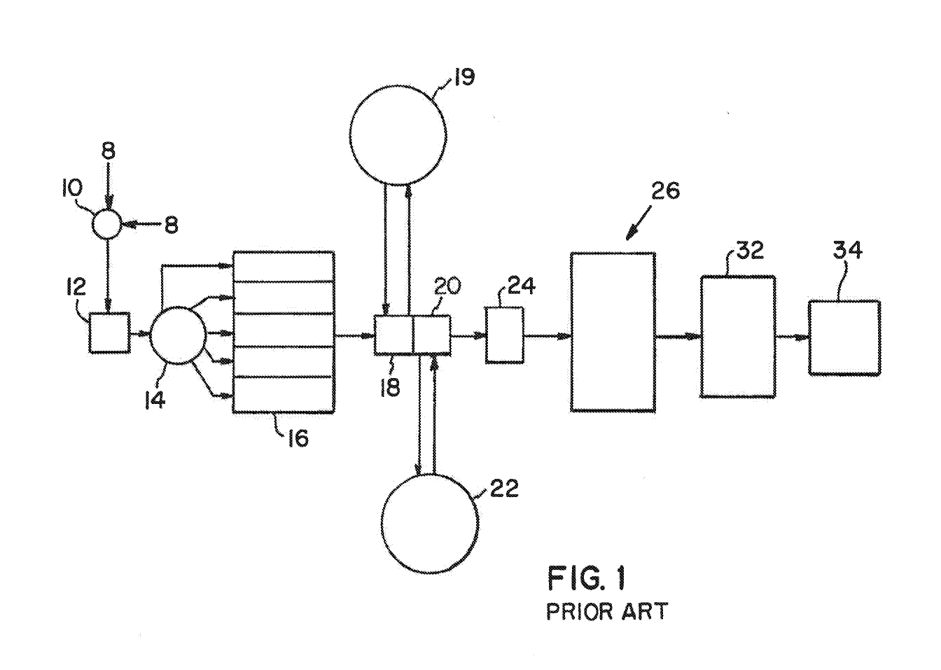

FIG. 1 shows a schematic diagram of the flow of wastewater through a typical prior art wastewater treatment plant. Wastewater 8 enters the influent manhole and gate valve 10 and flows to a raw sewage wet well 12. The wastewater is then pumped to a primary clarifier distribution box 14 and flows into primary clarifiers 16 for separation of solids from the flow. The water is pumped to a primary trickling filter wet well 18 and then pumped to a primary trickling filter 19, for removal of biological material from the water. Effluent from the primary trickling filter 19 then flows to a secondary trickling filter wet well 20 and is pumped to a secondary trickling filter 22, after which it enters a secondary clarifier distribution box 24 and then a secondary or final clarifier 26. In some systems trickling filters are run in parallel, while in other systems they are run sequentially. Following secondary clarification, the water flows to a disinfection facility 32 where the water is disinfected through the use of chlorine, hypochlorite, ultraviolet light or other processes, after which the outflow is directed to surface waters 34. As will be understood by one skilled in the art, numerous modifications to the above process are often made, depending on the type of wastewater being treated and other considerations. For example, some plants may have tertiary treatment after the secondary clarifiers, in which water would either flow or be pumped onto sand filters for removal of any extra fine suspended solids.

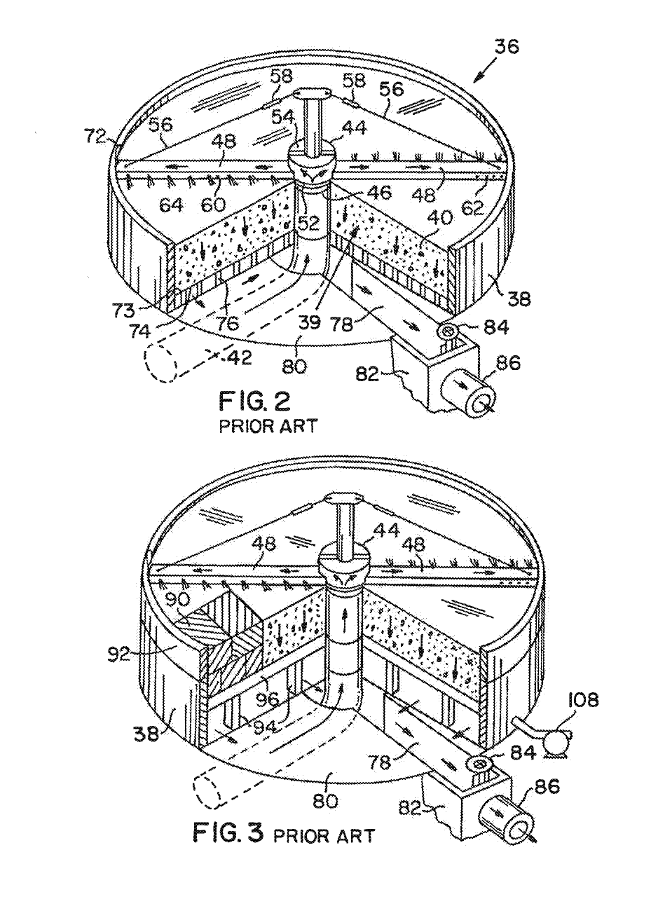

Referring now to FIG. 2, a prior art trickling filter tank 36 with retaining wall 38, receptacle area 39 holding the rock filter media 40 is shown. The filter media provides a large surface area upon which the biological slime growth develops. An inlet pipe 42 conveys wastewater to be treated to a trickling filter distributor 44 having a distributor base 46 to support rotating distributor arms 48 and distributor bearings 52 which allow the distributor arms 48 to rotate. The distributor 44 contains a center well 54 which provides for higher water head to maintain equal flow to distributor arms 48.

Stay rods 56 support the distributor arms 48 and turnbuckles 58 on the stay rods 56 permit adjusting and leveling of the distributor arms 48 to produce an even distribution of wastewater over the filter media 40. The speed of the distributor arms 48 is controlled with the speed retarder orifice 62 or with other means such as a mechanical driver.

Wastewater flows through the inlet pipe 42 and is pumped up through the center well 54 of the distributor 44, through the distributor arms 48 and over the filter media 40 via outlet orifices 64 which control the flow of water to the filter media 40. Outlet orifices 64 are adjustable to provide an even distribution of wastewater to each square foot of filter media 40. Splash plates 60 on the distributor arms 48 distribute the flow from the outlet orifices 64 evenly over the filter media 40.

An arm dump gate 72 drains the distributor arms 48 and controls filter flies along the filter retaining wall 38. The dump gate 72 is also used for flushing the distributor arms 48 to remove accumulated debris that could block the outlet orifices 64.

In trickling filter systems with rock media, the media rests on a bottom 73 of the tank on a support grill 74 which lays directly on top of the underdrainage system 76. The support grill 74 holds the filter media 40 in place and keeps it out of the underdrainage system 76. The underdrainage system 76 is a network of pipes made of clay, plastic or other material directly beneath the media support grill 74. As will be understood by one skilled in the art, the underdrainage system in a trickling filter tank with rock media cannot store water, nor can it be adapted to do so. After the wastewater flows over the filter media 40, it falls to the underdrainage system 76 where it is conveyed to an underdrain channel 78 via a sloped floor 80. The underdrain channel 78 drains filter effluent to an outlet box 82, where it is collected before it flows to the next step in the wastewater treatment process. An outlet valve 84 in outlet box 82 is used for maintenance and is placed at the outlet pipe 86. In rock media systems, the outlet valve is normally in the open position but is closed when it becomes necessary to backwash the filter, such as when it becomes clogged.

FIG. 3 illustrates a prior art modern trickling filter tank in which old rock media has been replaced with plastic filter media 90 such as plastic cross flow block media. The modern tank functions as described above, with the following modifications as described below.

After wastewater flows over the plastic filter media 90, it falls to the floor where it is conveyed to an underdrain channel 78 via the sloped floor 80. The underdrain channel 78 drains filter effluent to an outlet box 82, where it may be collected before it flows to the next step in the wastewater treatment process. An outlet valve 84 at the outlet pipe 86 is used for maintenance purposes.

The height of the original retaining wall 38 may be extended with the addition of an extension wall 92 made of steel or other suitable material, for the purpose of adding additional media or providing a wind break to the media. A standard hydraulic flow-driven distributor (not shown) or a mechanical drive type of distributor 44 is used to control the speed of the distributor arms 48. Piers 94 made of concrete or other suitable material support cross-beams 96 made of concrete or other suitable material, which in turn support the plastic media 90 at a height of about one to three feet above the floor of the tank. In the prior art, the retaining wall 38 typically contains one or more ventilation ports (not shown) or forced air blowers 108 below the level of the filter media 90, to allow air to flow to the filter media 90. In both the old rock media tank shown in FIG. 2 and the modern trickling filter tank shown in FIG. 3, the underdrain channel 78 and outlet pipe 86 are positioned below the bottom (floor level) of the tank, such that the top of the outlet box 82 is at ground level. Also in both prior art tanks shown in FIGS. 2 and 3, the outlet valve 84 is positioned at the downstream end of the outlet box 82 and directly on the outlet pipe 86.

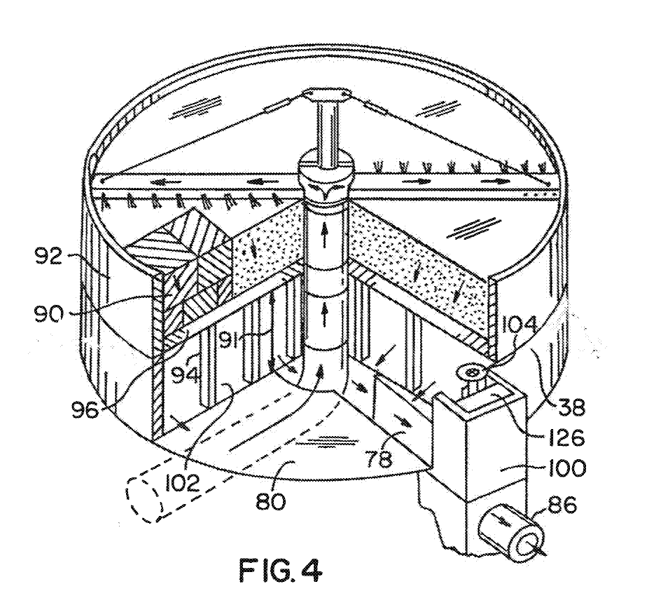

FIG. 4 shows an embodiment of the trickling filter made in accordance with the invention. Water is distributed through the tank and over the media as generally described above. A mechanically actuated drive is preferred to enhance the nitrification process and encourage the circulation of air through the media. In one embodiment, an existing older rock media tank or an existing newer plastic media tank has been modified according to the invention. The height of the original retaining wall 38 is extended with the addition of an extension wall 92 made of steel or other suitable material, to provide additional air space beneath the biological media, and to provide an optional wind wall above the level of the media. Optionally, the space underneath the media can be used as temporary storage for overflow water. The media support platform such as piers 94 made of concrete or other suitable material are extended in height above the floor 80 of the tank. The piers 94 and cross beams 96, also made of concrete or other suitable material, support the plastic media 90 at a height 91 of greater than about three feet above the floor 80 of the tank, preferably at least four feet or more above the floor 80 of the tank, more preferably about at least five feet, six feet or seven feet above the height of the floor 80.

In some preferred embodiments, the trickling filter has a wind wall (not shown) of at least three feet in height. In some embodiments, the wind wall is 4 feet, 5 feet, 6 feet or 7 feet or more in height, height being measured from the top of the biological media.

The trickling filter tank of the invention is optionally further modified with the addition of a flow control box 100. The flow control box 100 extends the height of the prior art outlet box 82 to a height near the height of the support platform cross beams 96 containing the media 90. The flow control box 100 contains a flow control assembly to set the elevation of water retained in the tank when storage is needed, such as a flow weir 126 or other suitable structure in combination with a flow restriction valve or gate 104, or a weir gate (as described in U.S. Pat. No. 7,238,286), as will be understood by one skilled in the art. When flow control is also used, a flow weir is adjustably sized at the maximum depth of the tank that will be used for storage, such that when full, the tank still contains sufficient air space 103 below the media 90 for ventilation. The size of the air space can be anywhere from a few inches to a foot or more, depending on the type of media used and the amount of aeration required, as will be determined by one skilled in the art. Aeration of the media can also be accomplished by other methods, such as aeration pipes through the media from the top of the tank (not shown). The flow restriction valve 104 is disposed adjacent to the flow weir 126. During normal operation of the tank, water flows over the filter media 90 and falls to the floor 80 where it is conveyed to an underdrain channel 78 via a sloped floor 80. The flow restriction valve 104, which regulates flow of water out of the tank, is in the open position and water flows through the underdrain channel 78, through the flow control box 100, into the outlet pipe 86 and to the next stage of processing in the wastewater treatment plant.

In additional embodiments, the trickling filter of the invention is built as a new tank, incorporating all of the modifications described above, including elevating the support platform for the filter media, and optionally, increasing the height of the flow control box and providing a flow control assembly such as a flow weir in combination with a flow restriction valve.

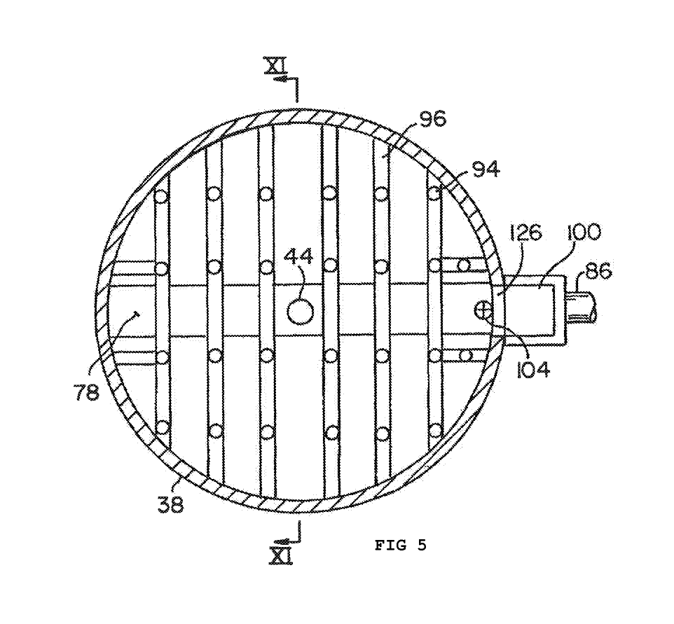

FIG. 5 is a top plan view of the embodiment shown in FIG. 4 without filter media. The retaining wall 38 of the tank is shown, with the underdrain channel 78, the distributor 44, the media support piers 94 and the cross-beams 96. Also shown is the flow control box 100 having a flow restriction valve 104 and a flow weir 126.

As will be understood by one skilled in the art, the plant operator of a trickling filter system must manage and take into account certain factors that affect the nitrification process. These factors include, for example, the efficiency of upstream treatment units and processes; the amount of dissolved oxygen in the water; the temperature, alkalinity and pH of the water, cBOD removal, toxic compounds, wet weather conditions, and overall facility design. Temperature, dissolved oxygen, alkalinity, pH and toxic compounds must be monitored regularly to make sure that conditions are optimal for the proper functioning of the biological media. For the purpose of the invention, it is assumed that these parameters are optimized for a trickling filter of the invention in the same manner as they would be optimized for any standard (without the invention) trickling filter system.

The invention is further illustrated by the following example.

### Example

### Implementation of a Modified Trickling Filter at a Wastewater Treatment Plant

A trickling filter was modified at a Pennsylvania wastewater treatment plant by providing a raised platform at 6 feet above ground level for support and storage of media. This platform created a plenum (air space) below the platform. The filter was substantially closed, except for the effluent opening. A wind wall of 6 feet above the level of the media was also built on the tank. The following measurements (Tables 1, 2 and 3) on effluent were made before and after the modifications.

TABLE 1
Plant values for Ammonium Nitrate Prior to Modification of Trickling Filter - 2004 (all units are mg/l)

| | January | | | | | | | | | | | |
|---|---|---|---|---|---|---|---|---|---|---|---|---|
| | 2010 | February | March | April | May | June | July | August | September | October | November | December |
| Influent | | | | | | | | | | | | |
| avg | 16.7 | 15.5 | 16.1 | 19.1 | 22.2 | 23.7 | 23.1 | 23.2 | 19.9 | 22.1 | 18.5 | 16.9 |
| max | 26.3 | 20.2 | 24.2 | 36.3 | 32.8 | 39.5 | 31.8 | 36.7 | 40.3 | 28.9 | 26.9 | 23.5 |
| min | 8.9 | 9.7 | 6.2 | 7.5 | 12.6 | 15.7 | 15.8 | 12.8 | 7.6 | 13.7 | 11.7 | 13.5 |
| Effluent | | | | | | | | | | | | |
| avg | 3.59 | 5.25 | 4.48 | 2.52 | 3.38 | 1.05 | 1.36 | 1.93 | 1.95 | 2.92 | 1.69 | 1.73 |
| max | 5.61 | 6.74 | 6.79 | 4.73 | 7.54 | 2.33 | 2.48 | 2.67 | 2.5 | 4.19 | 3.20 | 2.19 |
| min | 2.14 | 3.14 | 2.43 | 0.84 | 0.80 | 0.21 | 0.39 | 1.41 | 0.94 | 1.82 | 0.92 | 1.25 |

TABLE 2
Plant values for Ammonium Nitrate After Modification of Trickling Filter - 2009/2010 (all units are mg/l)

| | October | No- | De- | January* | Feb- | | | | | | | Sep- | | | |
|---|---|---|---|---|---|---|---|---|---|---|---|---|---|---|---|
| | 2009 | vember | cember | 2010 | ruary | March | April | May | June | July | August | tember | October | November | December** |
| Influent | | | | | | | | | | | | | | | |
| avg | 18.2 | 23.8 | 22.5 | 20.7 | 18.2 | 11.2 | 19.2 | 16.5 | 17.6 | 21.1 | 21.0 | 21.4 | 18.6 | 21.4 | 20.0 |
| max | 20.8 | 30.1 | 28.5 | 31.7 | 24.9 | 16.5 | 28.1 | 18.9 | 23.2 | 24.5 | 24.9 | 24.3 | 22.3 | 23.5 | 30.9 |
| min | 14.1 | 17.2 | 8.6 | 6.1 | 10.4 | 4.6 | 12.5 | 12.9 | 9.5 | 15.2 | 18.7 | 15.6 | 12.4 | 18.6 | 3.7 |
| Effluent | | | | | | | | | | | | | | | |
| avg | 1.01 | 1.80 | 1.65 | 1.3 | 2.49 | 0.29 | 0.55 | 0.4 | 0.37 | 0.47 | 0.43 | 0.32 | 0.16 | 0.45 | 1.23 |
| max | 1.60 | 2.98 | 2.59 | 3.03 | 5.85 | .46 | 1.67 | 1.39 | 0.64 | 1.21 | 0.90 | 0.52 | 0.24 | 0.84 | 2.58 |
| min | 0.41 | 0.99 | 0.18 | 0.39 | 0.25 | .13 | 0.13 | 0.06 | 0.20 | 0.21 | 0.20 | 0.18 | 0.10 | 0.14 | 0.17 |

*The values for October, November and December 2009 reflect the beginning stages of implementation of the raised plenum and the initial adjustment period of the system.
**The values for ammonium nitrate in December 2010 reflect the impact of 3.8 inches of rainfall in less than 24 hours. The filter was able to reconstitute itself to full nitrification in spite of cold weather conditions.

TABLE 3
Summary table—month by month comparison and % decrease
in Ammonium Nitrate before and after invention

| | Avg. Nitrate | Avg. Nitrate | |
|---|---|---|---|
| | Before Invention | After Invention | % Nitrate |
| Month | (2004) | (2010) | decrease |
| January | 3.59 | 1.30 | 64 |
| February | 5.25 | 2.49 | 53 |
| March | 4.48 | 0.29 | 94 |
| April | 2.52 | 0.55 | 78 |
| May | 3.38 | 0.40 | 89 |
| June | 1.05 | 0.37 | 65 |
| July | 1.36 | 0.47 | 65 |
| August | 1.93 | 0.43 | 78 |
| September | 1.95 | 0.32 | 86 |
| October | 2.92 | 0.16 | 95 |
| November | 1.69 | 0.45 | 73 |
| December | 1.73 | 1.23 | 29 |
| Annual Average | 2.65 | 0.71 | 73% |

* all values for ammonium nitrate are measured in plant effluent

The filters consistently achieved ammonia nitrogen removal well below 2 mg/l and 90% of the time below 1 mg/l, a level which is considered full nitrification.

The trickling filters of the invention can improve average monthly nitrification levels at least 30%, 40%, 50%, and 60% or more, as compared to nitrification levels in a trickling filter without the invention.

Whereas particular embodiments of this invention have been described above for purposes of illustration, it will be evident to those skilled in the art that numerous variations of the details of the invention may be made without departing from the invention as defined in the appended claims.

What is claimed is:

1. A method of improving nitrification in a wastewater treatment plant, the method comprising the steps of:
a) providing a trickling filter effluent water basin having biological filter media placed on a support platform positioned at least three feet above a bottom of the basin; and
(b) contacting the filter media with the wastewater.

2. The method of claim 1, wherein the support platform is at least 4 feet above the bottom of the basin.

3. The method of claim 1, wherein the support platform is at least 5 feet above the bottom of the basin.

4. The method of claim 1, wherein the support platform is at least 6 feet above the bottom of the basin.

5. The method of claim 1, the trickling filter effluent water basin further comprising a wind wall of at least 3 feet in height.

6. The method of claim 1, the trickling filter effluent water basin further comprising a wind wall of at least 4 feet in height.

7. The method of claim 1, wherein the trickling filter includes a mechanically activated distributor arm.

8. The method of claim 1, wherein the wastewater is further processed within the wastewater treatment plant, such as by any one or more of the steps of clarification, filtration and/or disinfection.

9. The method of claim 1, wherein the trickling filter effluent water basin is a substantially closed system with the exception of an outlet pipe for effluent out of the basin.

10. The method of claim 1, wherein average monthly nitrification is improved at least 30% as compared to a tricking filter without the invention.

11. The method of claim 1, wherein average monthly nitrification is improved at least 40% as compared to a tricking filter without the invention.

12. The method of claim 1, wherein average monthly nitrification is improved at least 50% as compared to a tricking filter without the invention.

13. A trickling filter effluent water basin comprising: a) a retaining wall; b) a support platform to support filter media positioned at a height at least 3 feet above a bottom of the basin; and c) an outlet pipe in fluid communication with the storage space, wherein the trickling filter effluent water basin is a substantially closed system with the exception of an outlet pipe for effluent out of the basin.

14. The trickling filter of claim 13, further comprising a mechanically activated distributor arm.
